(19) United States
(12) Patent Application Publication
(10) Pub. No.: US 2009/0058841 A1
(43) Pub. Date: Mar. 5, 2009

(54) PLASMA DISPLAY AND DRIVING METHOD THEREOF

(76) Inventors: Jin-Woo Jung, Suwon-si (KR); Dong-Myung Lee, Suwon-si (KR)

Correspondence Address: CHRISTIE, PARKER & HALE, LLP, PO BOX 7068, PASADENA, CA, 91109-7068, US

(21) Appl. No.: 12/038,758

(22) Filed: Feb. 27, 2008

(30) Foreign Application Priority Data
Sep. 3, 2007 (KR) 10-2007-0089020

(51) Int. Cl. G06F 3/038

(52) U.S. Cl. 345/211

(57) ABSTRACT

A plasma display and a method of driving the plasma display. The plasma display includes a plasma display panel including a plurality of discharge cells corresponding to sustain electrodes and scan electrodes. A first transistor is coupled between a first power source and a node coupled to the scan electrodes. A second transistor and a diode are coupled in series between a second power source and the node. The first and second transistors are alternately turned on during a sustain period, and the diode is configured to interrupt a current flowing from the second power source to the node.

### CROSS-REFERENCE TO RELATED APPLICATION

This application claims priority to and the benefit of Korean Patent Application No. 10-2007-0089020 filed in the Korean Intellectual Property Office on Sep. 03, 2007, the entire contents of which are incorporated herein by reference.

### BACKGROUND OF THE INVENTION

1. Field of the Invention

The present invention relates to a plasma display and a driving method thereof.

2. Description of the Related Art

A plasma display panel (PDP) is a flat panel display that uses plasma generated by gas discharge to display characters or images. It includes, depending on its size, more than several hundreds of thousands to millions of discharge cells (hereinafter referred to as “cells”) arranged in a matrix format. A plasma display displays images by driving the cells with frames each divided into a plurality of subfields.

In addition, the plasma display is driven by dividing a frame into a plurality of subfields each having a predetermined luminance weight value. In each subfield, a scan pulse is sequentially applied to a plurality of scan electrodes to select turn-on cells and turn-off cells during an address period, and a high level voltage and a low level voltage are alternately applied to electrodes during a sustain period to perform sustain discharges to display an image during the sustain period.

A negative voltage may be applied to the scan electrode to select a discharge cell during the address period, or a voltage at the scan electrode may be reduced to the negative voltage to initialize the discharge cell during a reset period. Here, a cut-off switch is used to cut off current flowing from a 0V side where a potential is higher than a negative voltage side where the potential is lower during a period for applying a negative voltage of the reset period or a period for applying a negative voltage of the address period.

Since displacement currents and discharge currents flow in the cut-off switch during the sustain period, a current flow may be generated, and efficiency is reduced.

In addition, since the cut-off switch requires a gate driver and a heat dissipating plate, the circuit configuration is more complicated and the circuit cost is increased.

The above information disclosed in this Background section is only for enhancement of understanding of the background of the invention, and therefore, it may contain information that does not form the prior art that is already known in this country to a person of ordinary skill in the art.

### SUMMARY OF THE INVENTION

Aspects of the present invention provide a plasma display for efficiently performing a sustain discharge during a sustain period. In addition, aspects of the present invention provide a plasma display with a simplified circuit configuration and reduced circuit cost, and a driving method thereof. According to an exemplary embodiment of the present invention, a plasma display includes a plasma display panel configured to be driven during a plurality of subfields, each subfield including and a sustain period. The plasma display panel includes a plurality of discharge cells corresponding to sustain electrodes and scan electrodes. The plasma display also includes a first power source for supplying a first voltage, a second power source for supplying a second voltage that is lower than the first voltage, a first transistor, a second transistor, and a first diode. The first transistor is coupled between a node coupled to the scan electrodes and the first power source. The second transistor and the first diode are connected in series between the second power source and the node. The first transistor and second transistor are alternately turned on during the sustain period, and the first diode is configured to interrupt a current flowing from the second power source to the node.

According to another exemplary embodiment of the present invention, a plasma display includes a plasma display panel configured to be driven during a plurality of subfields, each subfield including an address period and a sustain period. The plasma display panel includes a plurality of discharge cells corresponding to sustain electrodes and scan electrodes; The plasma display also includes a first power source for supplying a first voltage, a second power source for supplying a second voltage that is higher than the first voltage, a first transistor, a second transistor, and a first diode. The first transistor is connected between a node coupled to the scan electrodes and the first power source. The second transistor and the first diode are connected in series between the second power source and the node. The first transistor is turned on during the address period to apply the first voltage to the scan electrodes through the node. The second transistor is turned on during a part of the sustain period to apply the second voltage to the scan electrodes through the node. The first diode is configured to interrupt a current flowing from the second power source to the node.

According to a third exemplary embodiment of the present invention, it provides a driving method of a plasma display. The plasma display includes a plasma display panel configured to be driven during a plurality of subfields. Each subfield includes an address period and a sustain period. The plasma display panel includes a plurality of discharge cells corresponding to sustain electrodes and scan electrodes. A first voltage is sequentially applied to the plurality of scan electrodes during the address period, a second voltage and a third voltage, that is lower than the second voltage and is higher than the first voltage, are alternately applied to the plurality of scan electrodes during the sustain period. A current path from a second power source to a first power source is interrupted during the address period by using a diode coupled between the first power source for supplying the first voltage and the second power source for supplying the second voltage.

### BRIEF DESCRIPTION OF THE DRAWINGS

FIG. 1 is a block diagram of a plasma display according to an exemplary embodiment of the present invention.

FIG. 2 is a schematic diagram representing a driving circuit of a scan electrode driver according to a first exemplary embodiment of the present invention.

FIG. 3 is a timing diagram representing panel voltage waveforms and an operation mode of the driving circuit shown in FIG. 2.

FIG. 4A and FIG. 4B are schematic diagrams representing operations of the driving circuit shown in FIG. 3 during a reset period and an address period, respectively.

FIG. 5A to FIG. 5D are schematic diagrams representing the operation of the driving circuit shown in FIG. 3 during a sustain period.

FIG. 6 is a schematic diagram representing a driving circuit of a scan electrode driver according to a second exemplary embodiment of the present invention.

FIG. 7 is a schematic diagram of a driving circuit of a scan electrode driver according to a third exemplary embodiment of the present invention.

FIG. 8 is a schematic diagram representing a driving circuit of a scan electrode driver according to a fourth exemplary embodiment of the present invention.

FIG. 9 is a schematic diagram of a driving circuit of a scan electrode driver according to a fifth exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise,” and variations such as “comprises” and “comprising,” will be understood to imply the inclusion of stated elements but not the exclusion of any other elements.

A plasma display according to an exemplary embodiment of the present invention and a driving method thereof will be described.

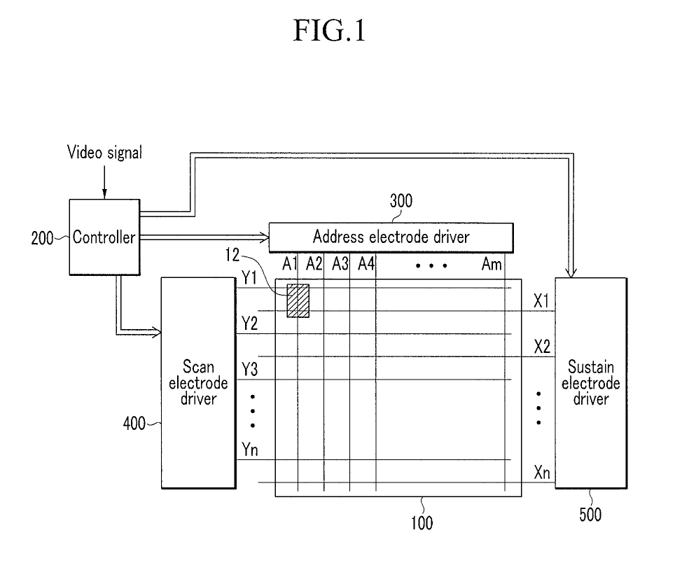

FIG. 1 is a block diagram of a plasma display according to an exemplary embodiment of the present invention.

As shown in FIG. 1, the plasma display according to the exemplary embodiment of the present invention includes a plasma display panel (PDP) 100, a controller 200, an address electrode driver 300, a scan electrode driver 400, and a sustain electrode driver 500.

The PDP 100 includes a plurality of address electrodes A1 to Am extending in a column direction, and a plurality of sustain electrodes X1 to Xn and scan electrodes Y1 to Yn extending in a row direction in pairs. The sustain electrodes X1 to Xn are formed corresponding to the scan electrodes Y1 to Yn, respectively. Discharge spaces at crossing regions of the address electrodes A1 to Am and the sustain and scan electrodes X1 to Xn and Y1 to Yn form discharge cells 110 (hereinafter referred to as “cells”). It is to be noted that the above construction of the PDP is only an example, and panels having different structures, to which a driving waveform to be described later can be applied, may be applied to the present invention.

The controller 200 receives an external video signal and outputs an address electrode driving control signal, a sustain electrode driving control signal, and a scan electrode driving control signal. The controller 200 divides one frame into a plurality of subfields respectively having weights according to the external video signal, and the respective subfields each include an address period and a sustain period. The address period is for selecting turn-on/turn-off cells (i.e., cells to be turned on/off), and the sustain period is for performing a display operation by sustain-discharging the turn-on cells. In addition, at least one of the plurality of subfields may further include a reset period. The reset period is for initializing at least one of the plurality of cells.

The address electrode driver 300 applies a driving voltage to the plurality of address electrodes A1 to Am according to the address electrode driving control signal from the controller 200.

The scan electrode driver 400 applies a driving voltage to the plurality of scan electrodes Y1 to Yn according to the scan electrode driving control signal from the controller 200.

The sustain electrode driver 500 applies a driving voltage to the plurality of sustain electrodes X1 to Xn according to the sustain electrode driving control signal from the controller 200.

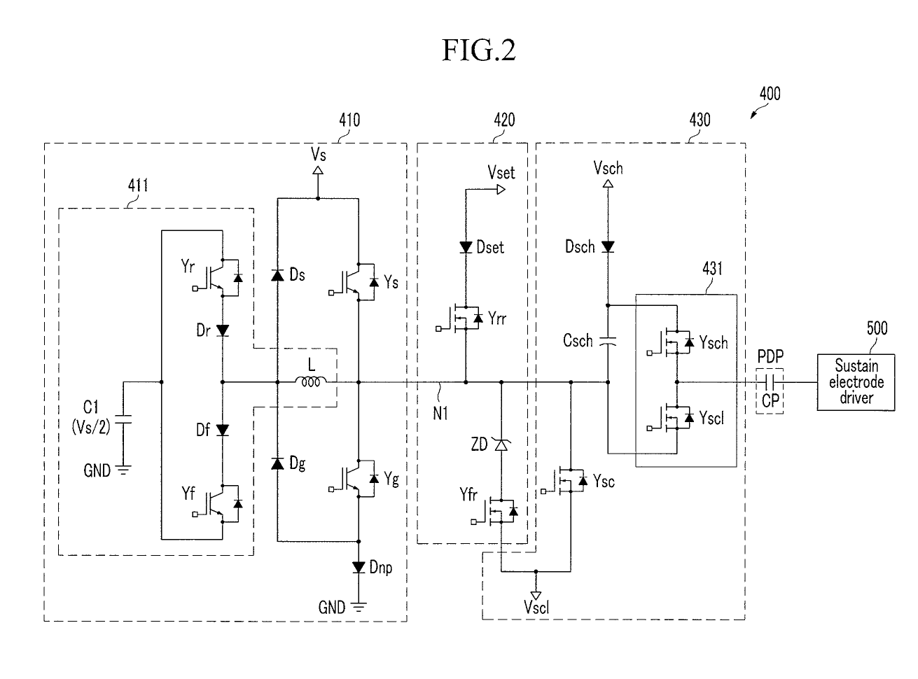

The scan electrode driver 400 shown in FIG. 1 will now be described with reference to FIG. 2.

FIG. 2 is a schematic diagram representing a driving circuit of the scan electrode driver 400 according to a first exemplary embodiment of the present invention. In FIG. 2, only one sustain electrode X and one scan electrode Y are shown for better understanding and ease of description, and a capacitive component formed by the sustain electrode X and the scan electrode Y is shown as a panel capacitor Cp. The terminal of the panel capacitor Cp connected to the sustain electrode driver 500 corresponds to the sustain electrode X, and the other terminal of the panel capacitor Cp corresponds to the scan electrode Y. In addition, since a configuration and an operation of the sustain electrode driver 500 is generally known to a person of ordinary skill in the art, a driving circuit of the sustain electrode driver 500 connected to the sustain electrode X is not illustrated in detail in FIG. 2.

As shown in FIG. 2, the driving circuit of the scan electrode driver 400 includes a sustain driver 410, a reset driver 420, and a scan driver 430.

The sustain driver 410 includes a power recovery circuit 411, transistors Ys and Yg, and diodes Ds, Dg, and Dnp. The power recovery circuit 411 includes transistors Yr and Yf, an inductor L, diodes Dr and Df, and a capacitor C1.

The transistor Ys is connected to a power source Vs for supplying a Vs voltage and a connection node N1, and the transistor Yg and the diode Dnp are connected in series between a ground terminal (e.g., a power source at 0V) for supplying a 0V voltage and the connection node N1. In addition, an emitter of the transistor Yg is connected to an anode of the diode Dnp, and a cathode of the diode Dnp is connected to the ground terminal.

A first terminal of the capacitor C1 is connected to a collector of the transistor Yr and an emitter of the transistor Yf. A voltage between the Vs voltage and the 0V voltage (e.g., a voltage Vs/2 in the middle of the Vs voltage and the 0V voltage) is charged in the capacitor C1.

In addition, the diode Dr is connected between an emitter of the transistor Yr and the connection node N1, and the diode Df is coupled between a collector of the transistor Yf and the connection node N1. The diode Dr interrupts a current path caused by a body diode of the transistor Yr, and the diode Df interrupts a current path caused by the body diode of the transistor Yf. However, when the transistors Yr and Yf have no body diode, the diodes Dr and Df may be eliminated.

A first terminal of the inductor L is connected to the connection node N1, and a second terminal of the inductor L is connected to a node connected with the diodes Dr and Df. In addition, the second terminal of the inductor L is connected to an anode of the diode Ds and a cathode of the diode Dg, and a cathode of the diode Ds and an anode of the diode Dg are respectively connected to the power source Vs and the emitter of the transistor Yg.

In the power recovery circuit 411, the connection order of the diode Df and the transistor Yf may be switched, and the connection order of the diode Dr and the transistor Yr may be switched.

The reset driver 420 includes transistors Yrr and Yfr, a diode Dset, and a Zener diode ZD

A drain of the transistor Yrr is connected to a power source Vset for supplying a Vset voltage, and a source of the transistor Yrr is connected to the connection node N1. The transistor Yrr gradually increases a voltage at the scan electrode Y through the connection node N1. In addition, the diode Dset is connected between the power source Vset and the transistor Yrr in a direction to interrupt a current caused by the body diode of the transistor Yrr.

The transistor Yfr is connected between a power source Vscl for supplying a Vscl voltage and the connection node N1, and the transistor Yfr gradually decreases the voltage at the scan electrode Y through the connection node N1.

The Zener diode ZD is connected between the transistor Yfr and the connection node N1, and the voltage at the scan electrode Y may be reduced to a voltage Vnf that is higher than the Vscl voltage by a breakdown voltage of the Zener diode ZD when the transistor Yfr is turned on. In other embodiments, the Zener diode ZD may be connected between the power source Vscl and the transistor Yfr.

The scan driver 430 includes a scan circuit 431, a capacitor Csch, a diode Dsch, and a transistor Ysc. While one scan circuit 431 is illustrated in FIG. 2, a plurality of scan circuits 431 may be connected to the respective scan electrodes Y1 to Yn so as to sequentially select the plurality of scan electrodes Y1 to Yn during the address period. The plurality of scan circuits 431 may be formed as an integrated circuit. The sustain driver 410 and the reset driver 420 that are driving circuits in the scan driver 400 are connected to the plurality of scan electrodes Y1 to Yn through the scan circuits 431.

The scan circuit 431 includes transistors Ysch and Yscl. A source of the transistor Ysch and a drain of the transistor Yscl are connected to the scan electrode Y of the panel capacitor Cp. A drain of the transistor Ysch is connected to a first terminal of the capacitor Csch, and a second terminal of the capacitor Csch and a source of the transistor Yscl are connected to the connection node N1. The transistor Ysc is connected between the power source Vscl and the connection node N1, and a cathode of the diode Dsch having an anode connected to a power source Vsch for supplying a Vsch voltage is connected to the connection node N1. Here, a voltage of substantially equal to (Vsch−Vscl) is charged in the capacitor Csch by turning on the transistor Ysc.

In addition, while the transistors are respectively illustrated as single transistors in FIG. 2, each of the transistors may be formed as one single transistor or a plurality of transistors that are connected in parallel.

Further, while the transistors Ysch, Yscl, Ysc, Yrr, and Yfr are illustrated as N-channel metal oxide semiconductor (NMOS) transistors having body diodes and the transistors Ys, Yg, Yr, and Yf are illustrated as N-channel insulated gate bipolar transistors having body diodes in FIG. 2, transistors having functions that are the same as or similar to NMOS transistors or insulated gate bipolar transistors may be used.

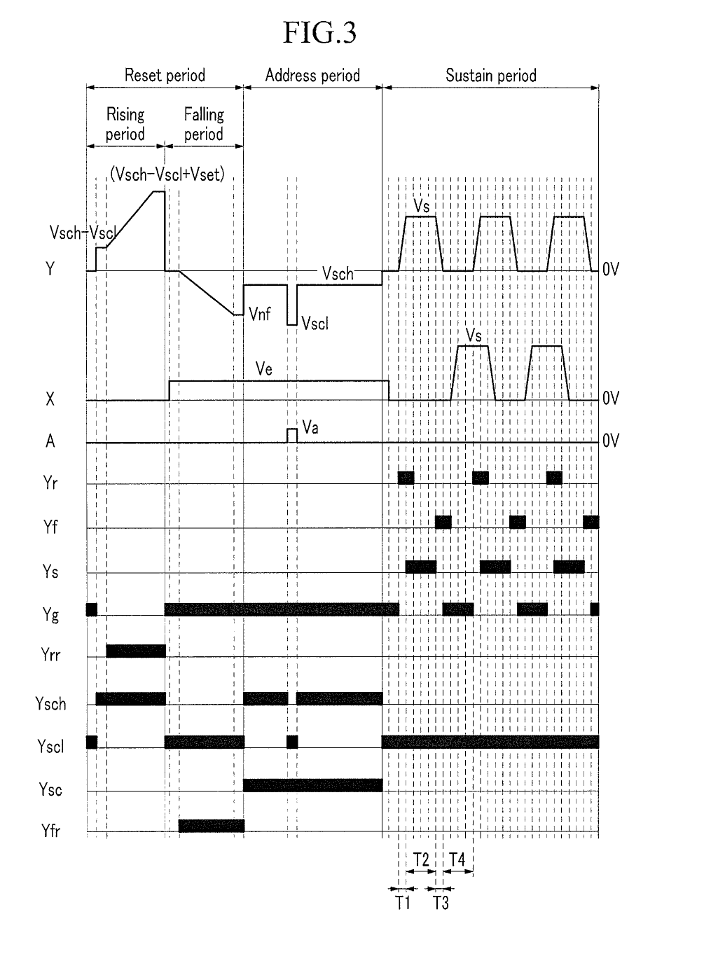

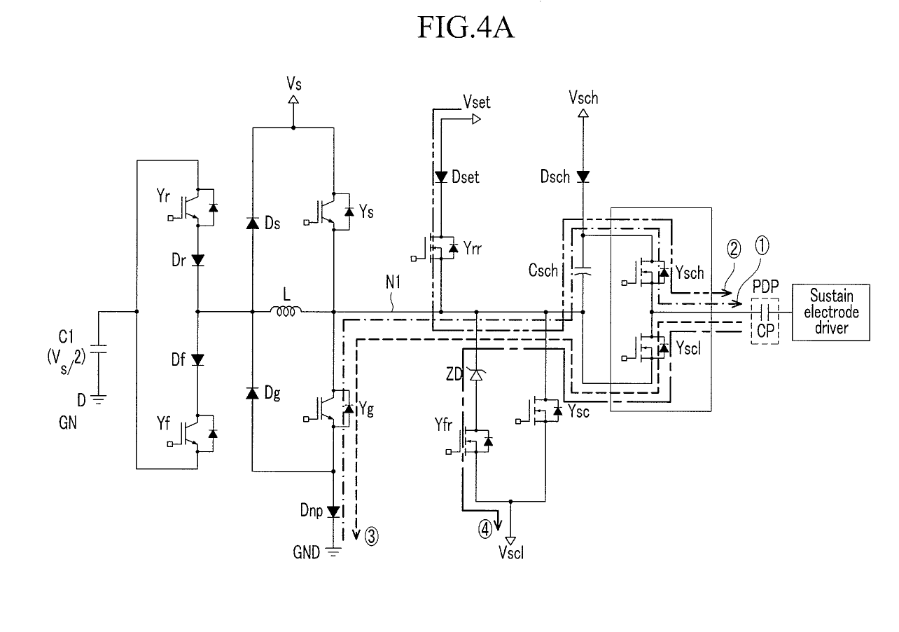

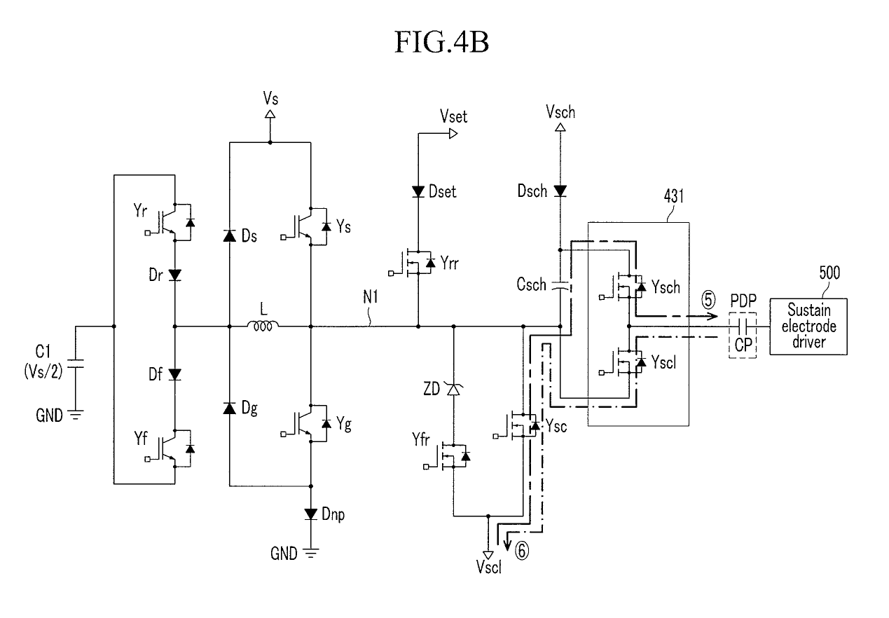

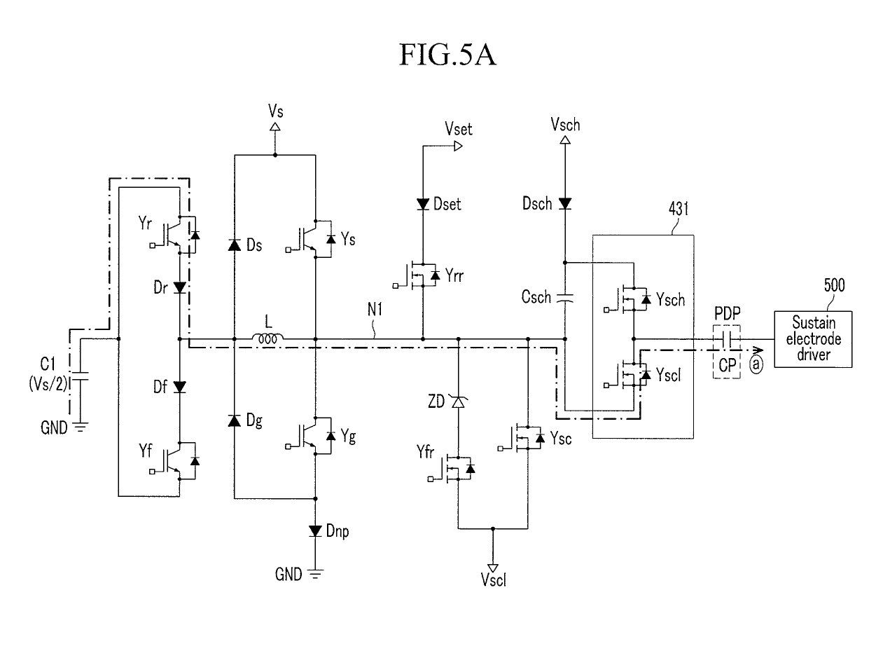

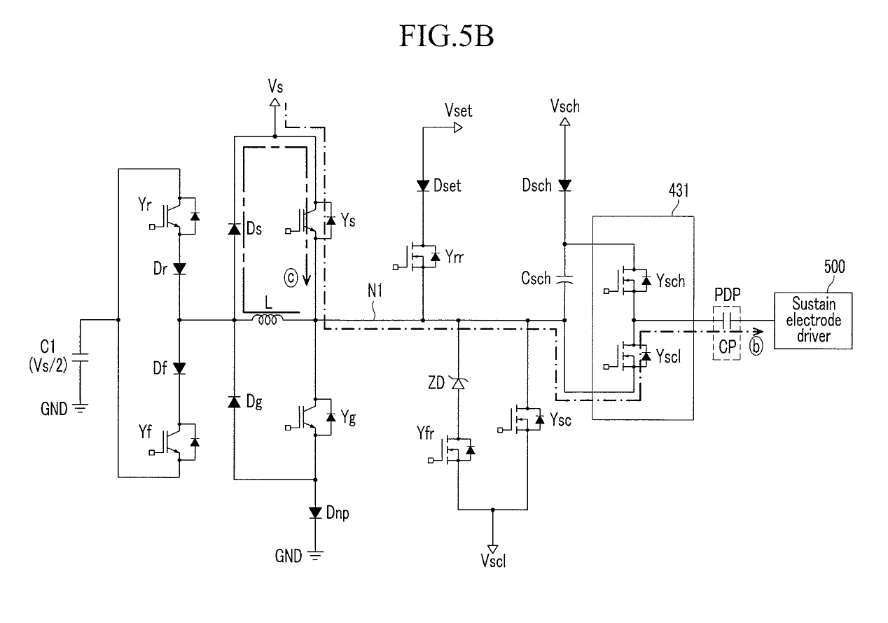

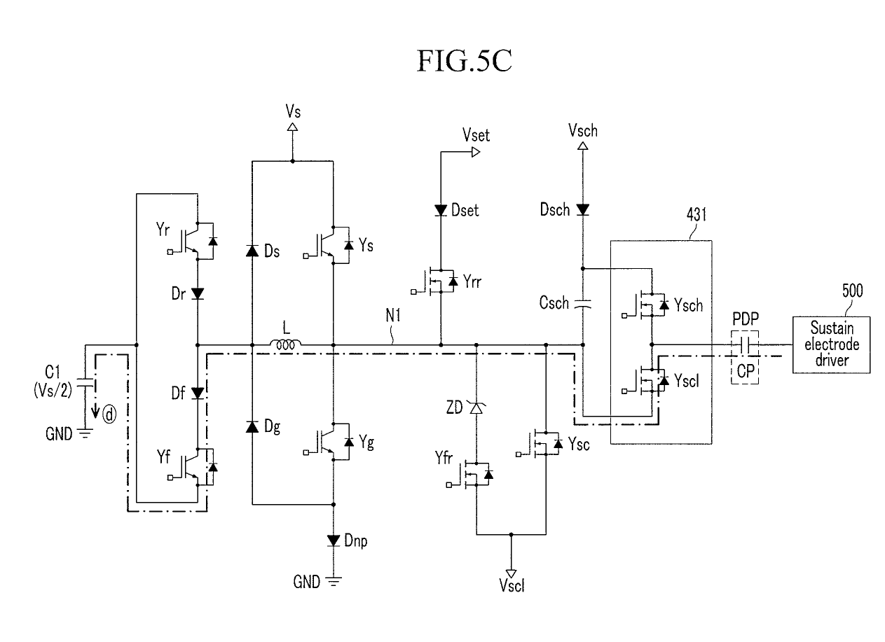

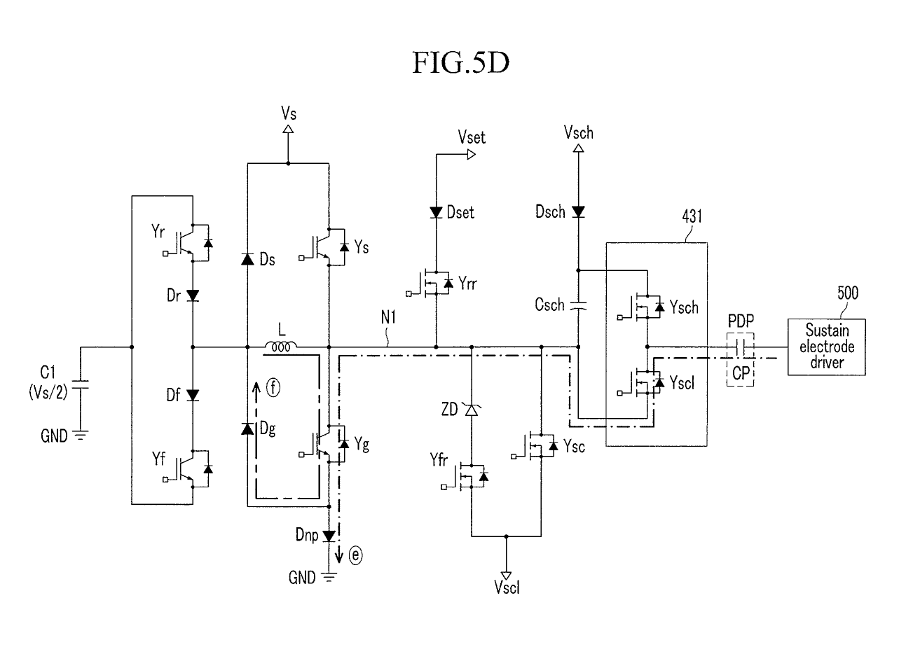

An operation of the driving circuit shown in FIG. 2 will now be described with reference to FIG. 3, FIG. 4A, FIG. 4B, and FIG. 5A to FIG. 5D. For better understanding and ease of description, detailed descriptions of an operation of the sustain electrode driver 500 will be omitted.

FIG. 3 is a timing diagram representing panel voltage waveforms and an operation mode of the driving circuit shown in FIG. 2. Firstly, an operation of the driving circuit shown in FIG. 3 during the reset period and the address period will now be described with reference to FIG. 4A and FIG. 4B.

FIG. 4A and FIG. 4B are schematic diagrams illustrating operations of the driving circuit shown in FIG. 3 during the reset period and the address period. Firstly, it is assumed that the transistors Yg and Yscl are turned on and the 0V voltage is applied to the scan electrode Y of the panel capacitor before the operation shown in FIG. 4A is started.

As shown in FIG. 4A, the transistor Ysch is turned on, and the transistor Yscl is turned off during a rising period of the reset period, and a voltage substantially equal to (Vsch−Vscl) charged in the capacitor Csch is applied to the scan electrode Y through a current path \hat{1} including the ground terminal, the transistor Yg, the capacitor Csch, and the transistor Ysch. Subsequently, the transistor Yrr is turned on, the transistor Yg is turned off, and the voltage at the scan electrode Y is gradually increased from the voltage substantially equal to (Vsch−Vscl) to a voltage substantially equal to (Vsch−Vscl+Vset) corresponding to a sum of the voltage of (Vsch−Vscl) and the Vset voltage through a current path \hat{2} including the power source Vset, the transistor Yrr, the capacitor Csch, and the transistor Ysch. In addition, the 0V voltage is applied to the sustain electrode X and the address electrode A during the rising period.

During a falling period of the reset period, the transistor Yrr is turned off, the transistors Yg and Yscl are turned on, and the 0V voltage is applied to the scan electrode Y through a current path \hat{3} including the panel capacitor Cp, the transistor Yscl, the diode Dnp, the transistor Yg, and the ground terminal. Subsequently, the transistor Yfr is turned on, and the voltage at the scan electrode Y is gradually decreased to a Vnf voltage through a current path \hat{4} including the panel capacitor Cp, the Zener diode ZD, the transistor Yfr, and the power source Vscl. Here, in the exemplary embodiment of the present invention, the diode Dnp interrupts a current path including the ground terminal for supplying the 0V voltage, the body diode of the transistor Yg, the Zener diode ZD, the transistor Yfr, and the power source Vscl when the transistor Yfr is turned on, and the voltage at the scan electrode Y is gradually decreased from the 0V voltage to the Vnf voltage. In addition, during the rising period, a Ve voltage is applied to the sustain electrode X, and the 0V voltage is applied to the address electrode A.

Referring to FIG. 4B, during the address period, the transistors Yfr and Yscl are turned off, the transistors Ysc and Ysch are turned on, and the Vsch voltage is applied to the scan electrode Y through a current path \hat{5} including the power sourceVscl, the transistor Ysc, the capacitor Csch, and the transistor Ysch. When the scan electrode of a turn-on discharge cell is selected, the transistor Ysch is turned off, the transistor Yscl is turned on, and the Vscl voltage is applied to the scan electrode Y through a current path \hat{6} including the panel capacitor Cp, the transistor Yscl, the transistor Ysc, and the power source Vscl. When the transistor Yscl is turned on and the Vscl voltage is applied to the scan electrode Y, the diode Dnp interrupts a current path including the ground terminal for supplying the 0V voltage, the body diode of the transistor Yg, the transistor Yscl, and the power source Vscl. Subsequently, when another scan electrode Y is selected, the transistor Ysch is turned on again, and the Vsch voltage is applied to the scan electrode Y through the current path \hat{5}. In addition, the Ve voltage is applied to the sustain electrode X during the address period, and a Va voltage is applied to the address electrode A when the Vscl voltage is applied to the scan electrode Y.

An operation of the driving circuit shown in FIG. 3 during the sustain period will now be described with reference to FIG. 5A to FIG. 5D.

FIG. 5A to FIG. 5D are schematic diagrams illustrating the operation of the driving circuit shown in FIG. 3 during the sustain period.

Firstly, during the sustain period, a high level voltage (e.g., the Vs voltage) and a low level voltage (e.g., the 0V voltage) are alternately applied to the scan electrode Y and the sustain electrode X, wherein the high level voltage on the scan electrode Y substantially overlaps with the low level voltage on the sustain electrode X, and vice versa.

It is assumed that the transistors Yg and Yscl are turned on and the 0V voltage is applied to the scan electrode Y of the panel capacitor Cp before an operation shown in FIG. 5A is started.

Referring to FIG. 5A, during a period T1 shown in FIG. 3, the transistor Yg is turned off, the transistor Yr is turned on, and the voltage at the Y electrode is increased from the 0V voltage through an LC resonance path â including the capacitor C1, the transistor Yr, the inductor L, the body diode of the transistor Yscl, and the panel capacitor Cp.

Referring to FIG. 5B, during a period T2 shown in FIG. 3, the transistor Ys is turned on, the transistor Yr is turned off, and the Vs voltage is applied to the scan electrode Y through a current path \hat{b} including the power source Vs, the transistor Ys, the body diode of the transistor Yscl, and the panel capacitor Cp. In this case, a reverse recovery current of the diode Dr flowing to the inductor L is free-wheeled through a current path ĉ including the inductor L, the diode Ds, the transistor Ys, and the inductor L, and the current is gradually decreased.

Referring to FIG. 5C, during a period T3 shown in FIG. 3, the transistor Ys is turned off, the transistor Yf is turned on, and the voltage at the scan electrode Y is decreased from the Vs voltage through a LC resonance path \hat{d} including the panel capacitor Cp, the transistor Yscl, the inductor L, the diode Df, the transistor Yf, and the capacitor C1.

Referring to FIG. 5D, during a period T4 shown in FIG. 3, the transistor Yf is turned off, the transistor Yg is turned on, and the 0V voltage is applied to the scan electrode Y through a current path ê including the panel capacitor Cp, the transistor Yscl, the transistor Yg, the diode Dnp, and the ground terminal. In this case, the reverse recovery current of the diode Dr flowing to the inductor L is free-wheeled through a current path \hat{f} including the inductor L, the transistor Yg, the diode Dg, and the inductor L, and the current is gradually decreased.

As described, since the periods T1 to T4 are repeated, the sustain pulse alternately having the Vs voltage and the 0V voltage may be applied to the scan electrode Y during the sustain period.

In addition, rather than using the transistors Yr and Yf and the diodes Dr and Df, a switching unit for alternately forming a current path from the capacitor C1 through the inductor L to the connection node N1 and a current path from the connection node N1 through the inductor L to the capacitor C1 may be used.

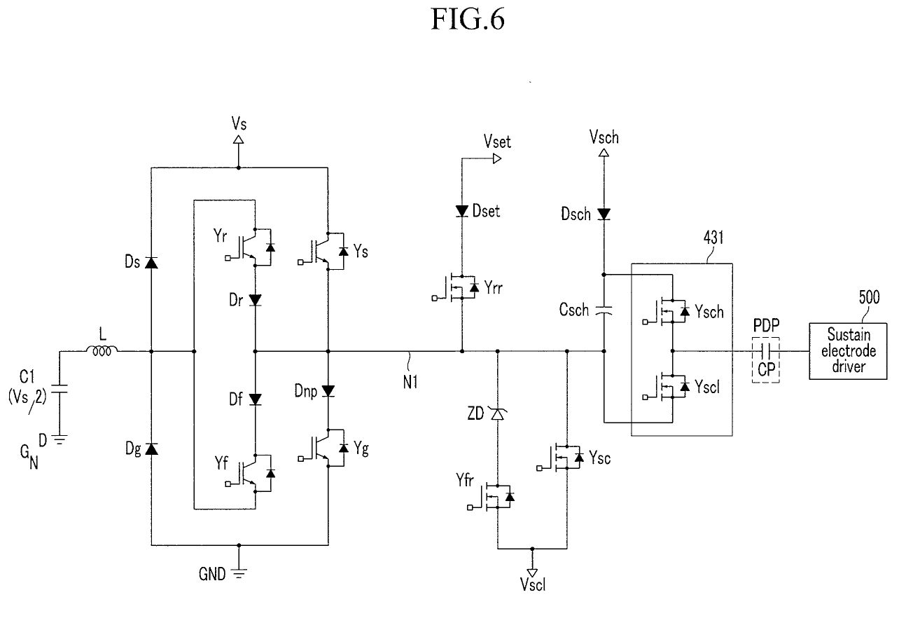

FIG. 6 is a schematic diagram representing a driving circuit of a scan electrode driver according to a second exemplary embodiment of the present invention.

As shown in FIG. 6, the driving circuit of the scan electrode driver according to the second exemplary embodiment of the present invention is the same as that of the first exemplary embodiment of the present invention except for a connection relationship between the diodes Dnp, Ds, and Dg and the inductor L.

In further detail, the first terminal of the inductor L is connected to the first terminal of the capacitor C1, and the second terminal of the inductor L is connected to the collector of the transistor Yr and the emitter of the transistor Yf. The transistor Yg and the diode Dnp are connected in series between the connection node N1 and the ground terminal. In FIG. 6, the diode Dnp is connected between the collector of the transistor Yg and the connection node N1. In the second exemplary embodiment of the present invention, when the transistors Ysc and Yfr are turned on, the diode Dnp may interrupt the current path through the body diode of the transistor Yg.

The anode of the diode Ds and the cathode of the diode Dg are connected to the first terminal of the inductor L, the cathode of the diode Ds and the anode of the diode Dg are respectively connected to the power source Vs and the ground terminal, and a free-wheeling path of the reverse current is formed.

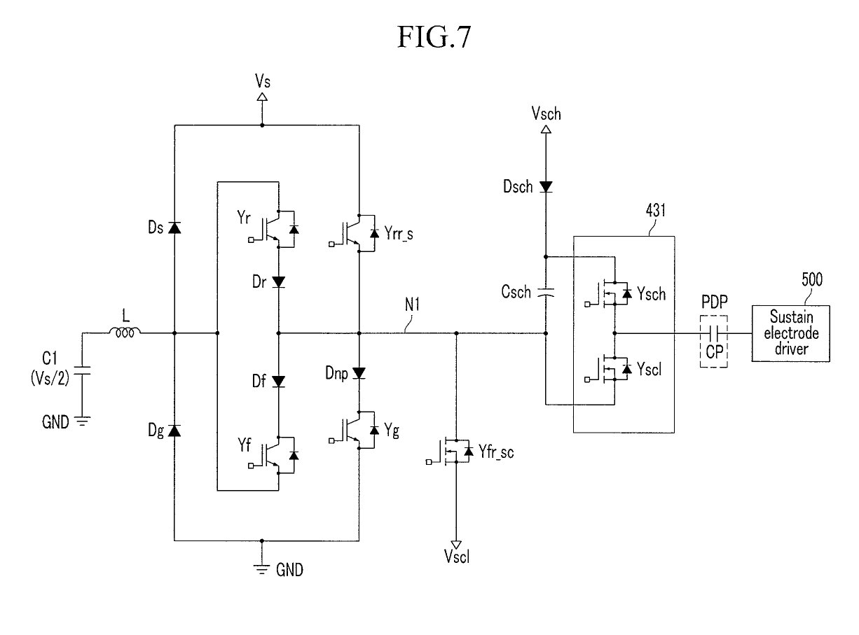

FIG. 7 is a diagram of a driving circuit of a scan electrode driver according to a third exemplary embodiment of the present invention.

As shown in FIG. 7, the driving circuit of the scan electrode driver according to the third exemplary embodiment of the present invention is the same as that of the second exemplary embodiment of the present invention except that the two transistors Yrr and Ys are integrated as one transistor Yrr_S, and the two transistors Yfr and Ysc are integrated as one transistor Yfr_sc.

In further detail, when the Vnf voltage shown in FIG. 3 is the same as the Vscl voltage, the transistor Yfr_sc for performing the operations of the transistor Yfr and the transistor Ysc shown in FIG. 2 may be connected between the power source Vscl for supplying the Vscl voltage and the connection node N1. When the Vset voltage is the same as the Vs voltage, the transistor Yrr_s for performing the operations of the transistor Yrr and the transistor Ys shown in FIG. 2 may be connected between the power source Vs for supplying the Vs voltage and the connection node N1.

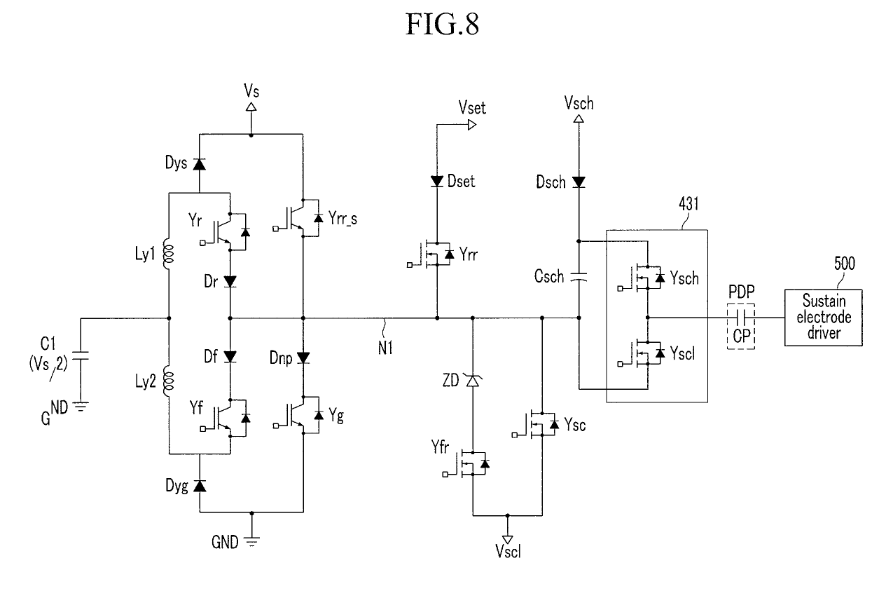

FIG. 8 is a schematic diagram representing a driving circuit of a scan electrode driver according to a fourth exemplary embodiment of the present invention.

As shown in FIG. 8, the driving circuit of the scan electrode driver according to the fourth exemplary embodiment of the present invention is the same as that of the second exemplary embodiment of the present invention except for an inductor Ly1 for increasing the voltage at the scan electrode Y and an inductor Ly2 for decreasing the voltage at the scan electrode Y.

In further detail, a first terminal of the inductor Ly1 is connected to the collector of the transistor Yr, and a first terminal of the inductor Ly2 is connected to the emitter of the transistor Yf. In addition, second terminals of the inductors Ly1 and Ly2 are connected to the first terminal of the capacitor C1. That is, the inductor Ly1 and the transistor Yr are connected in series between the capacitor C1 and the connection node N1, and a path for increasing the voltage at the scan electrode Y is formed. In addition, the inductor Ly2 and the transistor Yf are connected in series between the capacitor C1 and the connection node N1, and a path for decreasing the voltage at the scan electrode Y is formed.

A diode Dys is connected between the power source Vs for supplying the Vs voltage and the first terminal of the inductor Ly1 to form the free-wheeling path of the reverse current, and a diode Dyg is connected between the ground terminal for supplying the 0V voltage and the first terminal of the inductor Ly2.

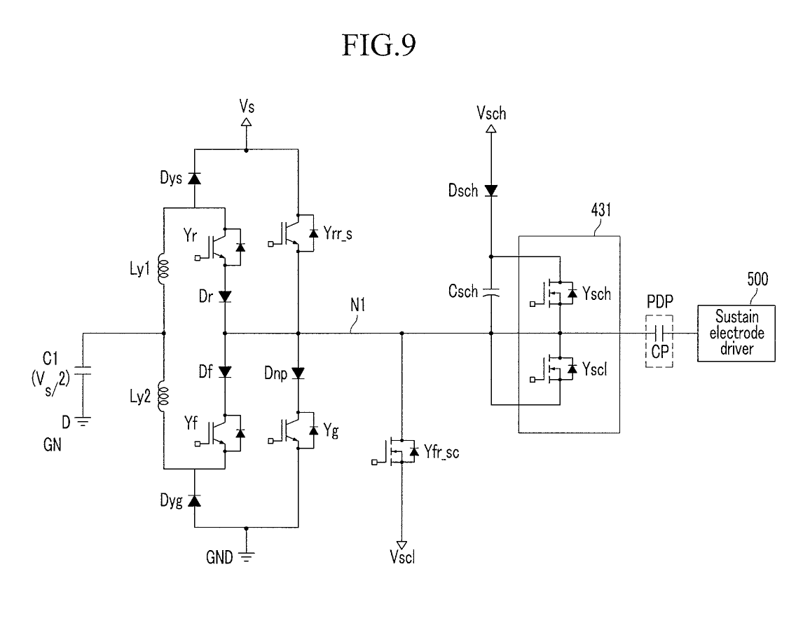

FIG. 9 is a diagram of a driving circuit of a scan electrode driver according to a fifth exemplary embodiment of the present invention.

As shown in FIG. 9, the driving circuit of the scan electrode driver according to the fifth exemplary embodiment of the present invention is the same as that of the fourth exemplary embodiment of the present invention except that the two transistors Yrr and Ys are integrated as one transistor Yrr_s and the two transistors Yfr and Ysc are integrated as one transistor Yfr_sc.

In further detail, when the Vset voltage is the same as the Vs voltage, the transistor Yrr_s for performing the operations of the transistor Yrr and the transistor Ys shown in FIG. 8 may be connected between the power source Vs for supplying the Vs voltage and the connection node N1. When the Vnf voltage is the same as the Vscl voltage, the transistor Yfr_sc for performing the operations of the transistor Yfr and the transistor Ysc shown in FIG. 8 may be connected between the power source Vscl for supplying the Vscl voltage and the connection node N1.

Furthermore, the driving circuits of the plasma display according to the second, third, fourth, and fifth exemplary embodiments of the present invention may perform the operation of the circuit shown in FIG. 3.

As described, in the plasma display according to the exemplary embodiments of the present invention, the diode Dnp interrupts a current flowing from the ground terminal for supplying the 0V voltage having a higher potential than the potential of the power source Vscl for supplying a negative voltage during the falling period of the reset period and the address period. According to the exemplary embodiments of the present invention, since the diode Dnp may be used rather a conventional switch, a circuit cost may be reduced and a circuit configuration may be simplified.

While it has been described in the exemplary embodiments of the present invention that the Vs voltage and the 0V voltage are alternately applied to the scan electrode Y and sustain electrode X during the sustain period, and the negative voltage is applied to the scan electrode Y during the reset period and the address period, the exemplary embodiments are not limited thereto, and the exemplary embodiments may be applied when the low level voltage applied during the sustain period is higher than the Vnf voltage of the reset period and the Vscl voltage of the address period.

While this invention has been described in connection with the exemplary embodiments, it is to be understood that the invention is not limited to the disclosed embodiments, on the contrary, it is intended to cover various modifications and equivalent arrangements included within the spirit and scope of the appended claims.

According to the exemplary embodiments of the present invention, the plasma display appropriately performs the sustain discharge during the sustain period. In addition, the circuit configuration of the plasma display may be simplified and the circuit cost may be reduced.

What is claimed is:

1. A plasma display comprising:
a plasma display panel configured to be driven during a plurality of subfields, each subfield comprising a sustain period, the plasma display panel comprising a plurality of discharge cells corresponding to sustain electrodes and scan electrodes;
a first power source for supplying a first voltage;
a second power source for supplying a second voltage that is lower than the first voltage;
a first transistor coupled between a node coupled to the scan electrodes and the first power source; and
a second transistor and a first diode coupled in series between the second power source and the node,
wherein the first transistor and the second transistor are alternately turned on during the sustain period, and the first diode is configured to interrupt a current flowing from the second power source to the node.

2. The plasma display of claim 1, further comprising:
a capacitor for supplying a voltage between the first voltage and the second voltage;
an inductor having a first terminal coupled to the node; and
a switching unit coupled to a second terminal of the inductor to form a current path from the capacitor to the node and a current path from the node to the capacitor.

3. The plasma display of claim 2, wherein a cathode of the first diode is coupled to the second power source, an anode of the first diode is coupled to a first terminal of the second transistor, and a second terminal of the second transistor is coupled to the node.

4. The plasma display of claim 3, further comprising:
a second diode coupled between the second terminal of the inductor and the first power source; and
a third diode coupled between the second terminal of the inductor and the first terminal of the second transistor.

5. The plasma display of claim 1, further comprising:
a capacitor for supplying a voltage between the first voltage and the second voltage;
an inductor having a first terminal coupled to the capacitor; and
a switching unit coupled between a second terminal of the inductor and the node to form a current path from the inductor to the node and a current path from the node to the inductor.

6. The plasma display of claim 5, further comprising:
a second diode coupled between the second terminal of the inductor and the first power source; and
a third diode coupled between the second terminal of the inductor and the second power source.

7. The plasma display of claim 1, further comprising:
a capacitor for supplying a voltage between the first voltage and the second voltage;
a first inductor and a third transistor coupled in series between the capacitor and the node; and
a second inductor and a fourth transistor coupled in series between the capacitor and the node.

8. The plasma display of claim 7, further comprising:
a second diode coupled between the first power source and a second node coupled to the first inductor and the third transistor; and
a third diode coupled between the second power source and a third node coupled to the second inductor and the fourth transistor.

9. The plasma display of claim 1, further comprising:
a third power source for supplying a third voltage that is lower than the second voltage; and
a third transistor coupled between the third power source and the node,
wherein each subfield further comprises an address period, and the third voltage is applied to the scan electrodes during the address period.

10. The plasma display of claim 9, wherein each subfield further comprises a reset period, and the third transistor is configured to gradually decrease a voltage at the scan electrodes during the reset period.

11. The plasma display of claim 1, wherein each subfield further comprises a reset period, and the first transistor is configured to gradually increase a voltage at the scan electrodes during the reset period.

12. A plasma display comprising:
a plasma display panel configured to be driven during a plurality of subfields, each subfield comprising an address period and a sustain period, the plasma display panel comprising a plurality of discharge cells corresponding to sustain electrodes and scan electrodes;
a first power source for supplying a first voltage;
a second power source for supplying a second voltage that is higher than the first voltage;
a first transistor coupled between a node coupled to the scan electrodes and the first power source; and
a second transistor and a first diode coupled in series between the second power source and the node,
wherein the first transistor is turned on during the address period to apply the first voltage to the scan electrodes through the node,
the second transistor is turned on during a part of the sustain period to apply the second voltage to the scan electrodes through the node, and
the first diode is configured to interrupt a current flowing from the second power source to the node.

13. The plasma display of claim 12, further comprising:
a third power source for supplying a third voltage that is higher than the second voltage; and
a third transistor coupled between the third power source and the node,
wherein the second and third transistors are alternately turned on during the sustain period.

14. The plasma display of claim 12, further comprising a Zener diode and a fourth transistor coupled in series between the node and the first power source,
wherein each subfield further comprises a reset period, and the fourth transistor is configured to decrease a voltage at the scan electrodes to a fourth voltage that is higher than the first voltage during the reset period.

15. A driving method of a plasma display comprising a plasma display panel configured to be driven during a plurality of subfields, each subfield comprising an address period and a sustain period, the plasma display panel comprising a plurality of discharge cells corresponding to sustain electrodes and scan electrodes, the driving method comprising:
sequentially applying a first voltage to the plurality of scan electrodes during the address period;
alternately applying a second voltage and a third voltage to the plurality of scan electrodes during the sustain period, the third voltage being lower than the second voltage and higher than the first voltage; and
interrupting a current path from a second power source to a first power source during the address period by configuring a diode coupled between the first power source for supplying the first voltage and the second power source for supplying the second voltage.

16. The driving method of claim 15, wherein:
the sequentially applying the first voltage comprises turning on a first transistor coupled between a node coupled to the plurality of scan electrodes and the first power source for supplying the first voltage;
the alternately applying the second voltage and the third voltage comprises alternately turning on a second transistor and a third transistor to apply the second voltage and the third voltage, respectively;
the second transistor is coupled between the node and the second power source for supplying the second voltage; and
the third transistor is coupled between the node and a third power source for supplying the third voltage.
